(19) United States
(12) Patent Application Publication
(10) Pub. No.: US 2005/0032579 A1
(43) Pub. Date: Feb. 10, 2005

(54) Split-boot replacement

(76) Inventor: Jesus Rey Amian, Waianae, HI (US)

Correspondence Address: JESUS REY AMIAN, 84 - 1015 HANA ST., WAIANAE, HI, 96792, US

(21) Appl. No.: 10/884,816

(22) Filed: Jul. 2, 2004

Related U.S. Application Data
(60) Provisional application No. 60/492,447, filed on Aug. 5, 2003.

(51) Int. Cl. F16D 3/84

(52) U.S. Cl. 464/175

(57) ABSTRACT

Split-Boot Replacement is a boot that is horizontally split on it's horizontal axis with an indent and an overlap. The indent and overlap could be on the inside as well as on the outside. The other end of the boot will be butted against and cupped by the indent. The overlap will rest on top or under the other end of the boot. Adhesive will be applied under or over the overlap and at both ends of the boot clamps will be placed to hold the ends of the boot creating one solid unit.

### BACKGROUND-DESCRIPTION OF INVENTION

Vehicle owners are often left with two choices when it comes to replacing the boots on their vehicle. The first option is to replace the boots themselves. The second option is to have a professional mechanic replace the boots for them. In, either case certain procedures are needed to be followed before the boots can be removed and replaced. As it is now the only way to replace the existing boots are to first jack up the vehicle. Second the removal of front tires. Third the removal of brake pads. Fourth the removal of the brake calipers. Fifth the removal of the rotor disc or drums. Sixth the removal of the stabilizer bar. Seventh the removal of the steering rod. Eighth the removal of the knuckles. Last the removal of the ball joints. Once all these parts are removed and the boots are in placed all the parts removed must all be put back correctly taking special attention to maintenance requirements that the manufacture requires. The reason for why all these parts need to be removed is because the existing boots come in one complete unit making it necessary to take these necessary steps.

The problem in doing it in this conventional style are as follows:
(a) vehicle owners need to have some knowledge of the mechanics of a vehicle.
(b) the length of time it takes to replace the boots.
(c) the difficulty in removing majority or all of the parts listed.
(d) the possibility of mistakes while removing and re-installing of parts removed.
(e) the high-priced to replace the boots.
(f) the need for special tools to complete the task.

The advantages of the prior invention are as follows:
(a) to provide protection for the gears from dirt, water and foreign objects.
(b) to provide protection to near by parts so that grease will not leak onto it. For example, brake pads and brake rotors.

U.S. Pat. No. 6,402,999B1 to Changize Sadr and Jamie White (Jun. 11, 2002) disclose Protective Boot for Automotive Component and Method of Making. U.S. Pat. No. 3,873,137 to Seiichi Yamaguchi (Mar. 25, 1975) discloses Bellows-Type Joint Assembly. The closure in the present boots are composed of thermoplastic elastomer resin and thermoplastic polyester elastomers that comprises hard segments composed of aromatic dicarboxylic acid and a low-molecular weight of 400 to 4000, for the use in the prior arts. However the boot can consist of any other material that can be bent without fracture, such as polyethlene, polypropylene, vinyl, nylon, rubber, leather, various impregnated or laminated fibrous materials, various plasticized materials, etc . . .

### BRIEF SUMMARY OF THE INVENTION

This invention is a boot that is split horizontally across its horizontal axis with an indent and an overlap. The boot will be held together with adhesive and clamps on both ends. The invention will have an accordion style feature for flexibility.

The advantages of this invention are as follows:
(a) it will simplify the replacement of the boots with minimal knowledge of the mechanics of a vehicle.
(b) it will reduce the length of time to replace worn or damage boots.
(c) it will reduce majority if not all of the possibilities of mistakes while replacing and installing new boots.
(d) it will reduce the cost of replacing damaged boots.
(e) a common screwdriver, wrench or a socket wrench is all that is required to replace damage boots.
(f) it will provide the same protection from dirt, water or foreign objects as in the prior art.
(g) it will prevent grease from leaking onto near by parts such as brake pads and brake rotors as in the prior art.

### BRIEF DESCRIPTION OF SEVERAL VIEWS OF THE DRAWINGS

FIG. 1 is an overall view of the invention, as it would be used in the vehicle.

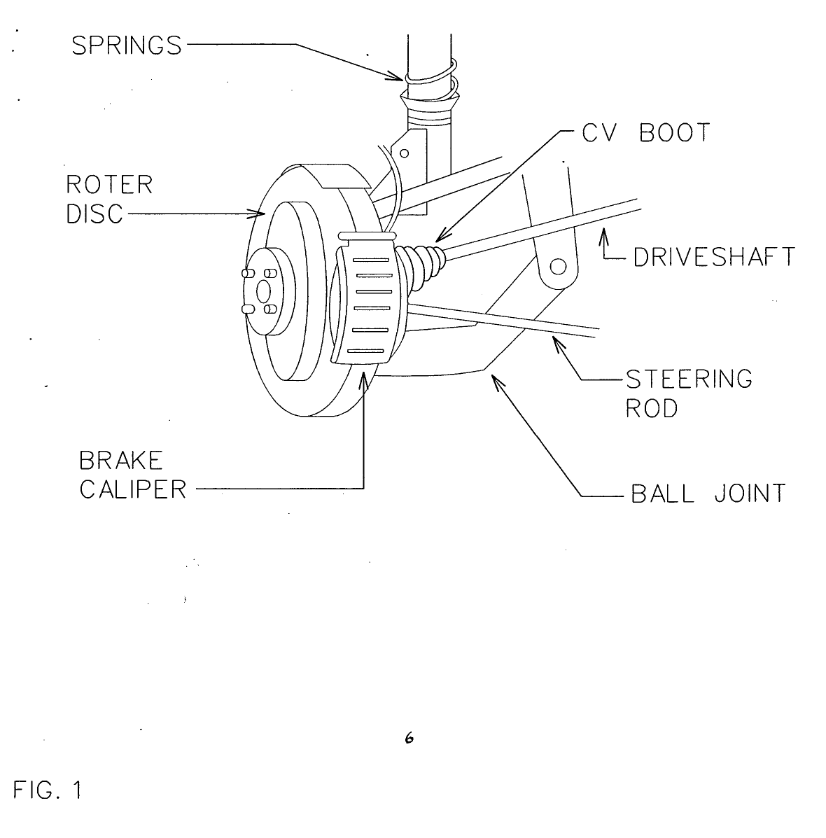

FIG. 2A is a frontal view of the invention with the indent on the inside and the overlap on the outside.

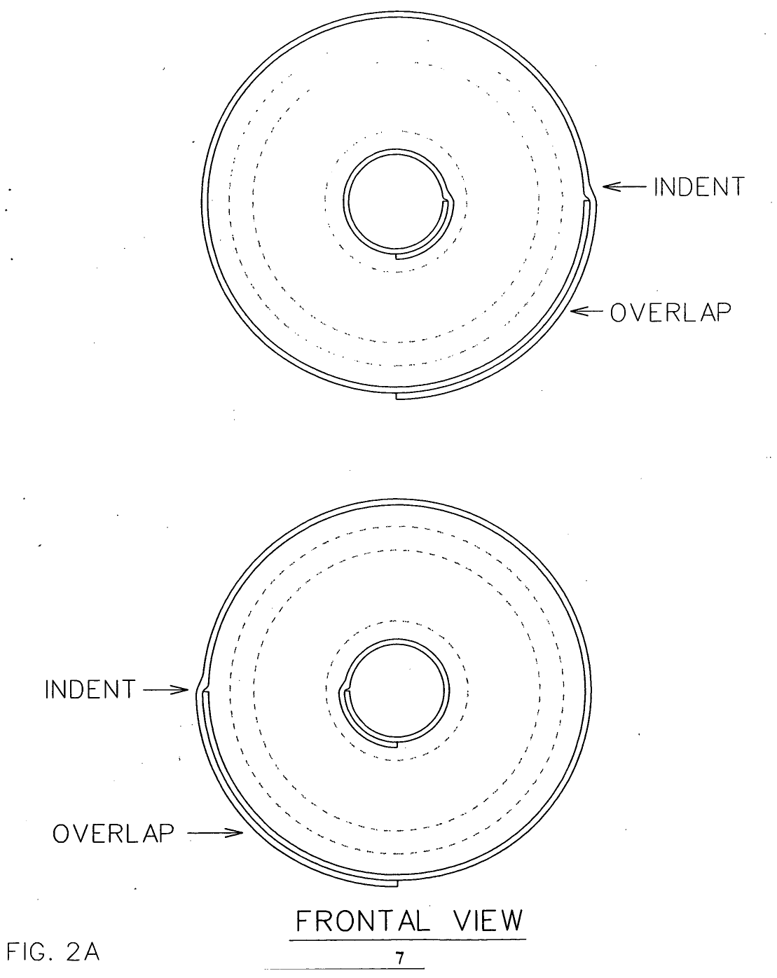

FIG. 2B is a frontal view of the invention with the indent on the outside and the overlap on the inside.

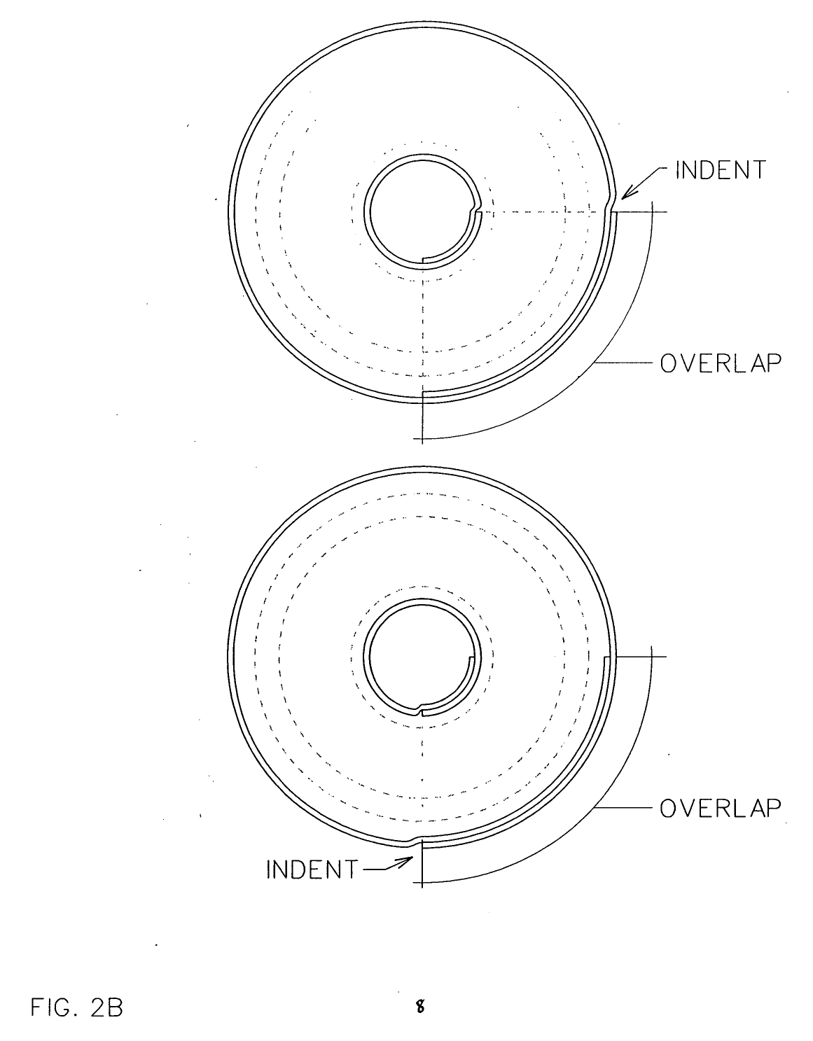

FIG. 2C Detail 1 is a frontal view of the invention with the indent on the inside and the overlap on the outside showing the rotation of the drive axle and the boot from the driver side when the vehicle is moving forward.

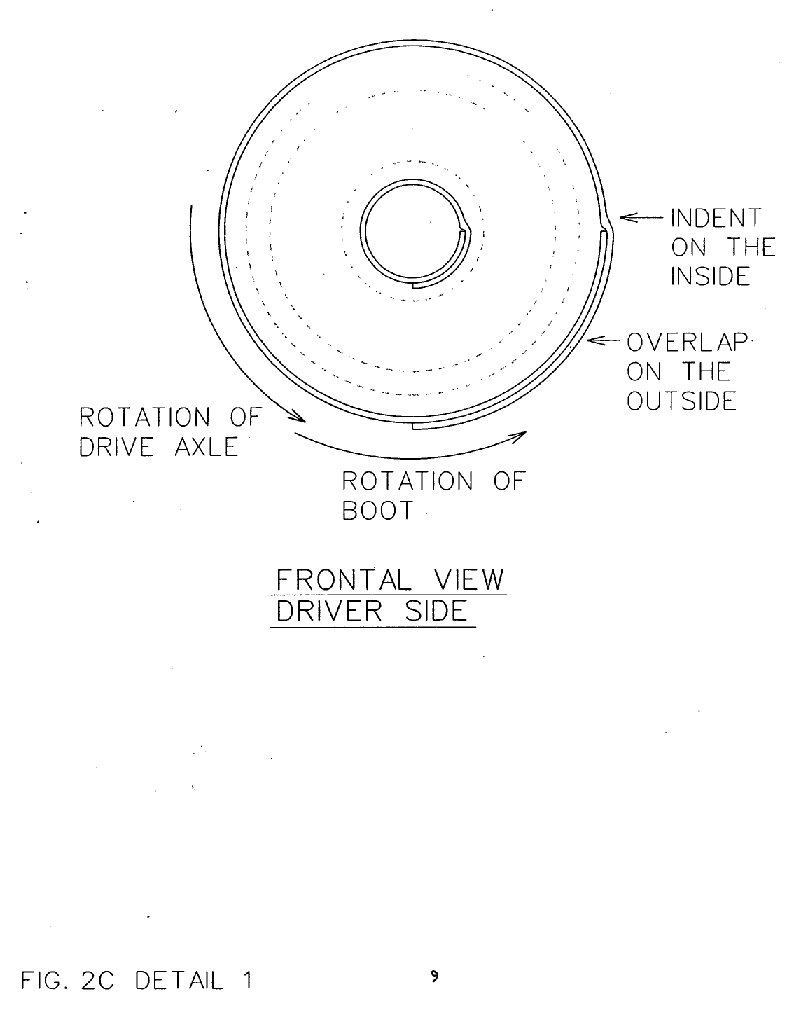

FIG. 2C Detail 2 is a frontal view of the invention with the indent on the outside and the overlap on the inside showing the rotation of the drive axle and the boot from the driver side when the vehicle is moving forward.

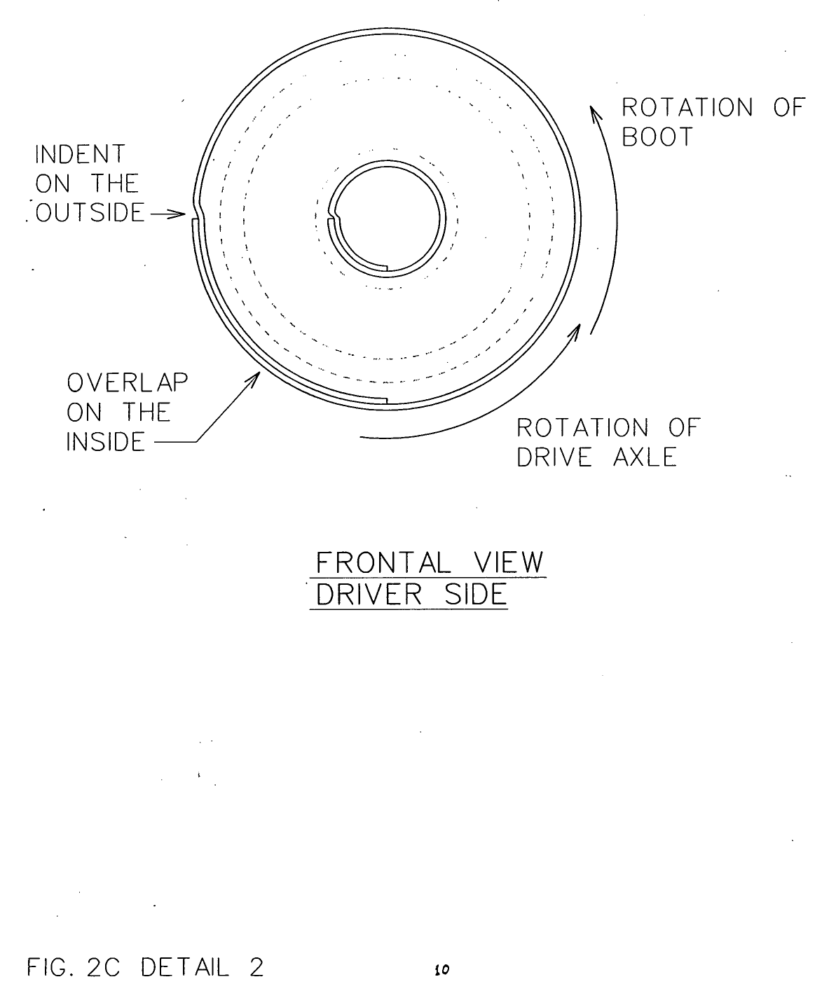

FIG. 3A is a side view of the invention with the overlap as the solid line and the hidden line as the indent.

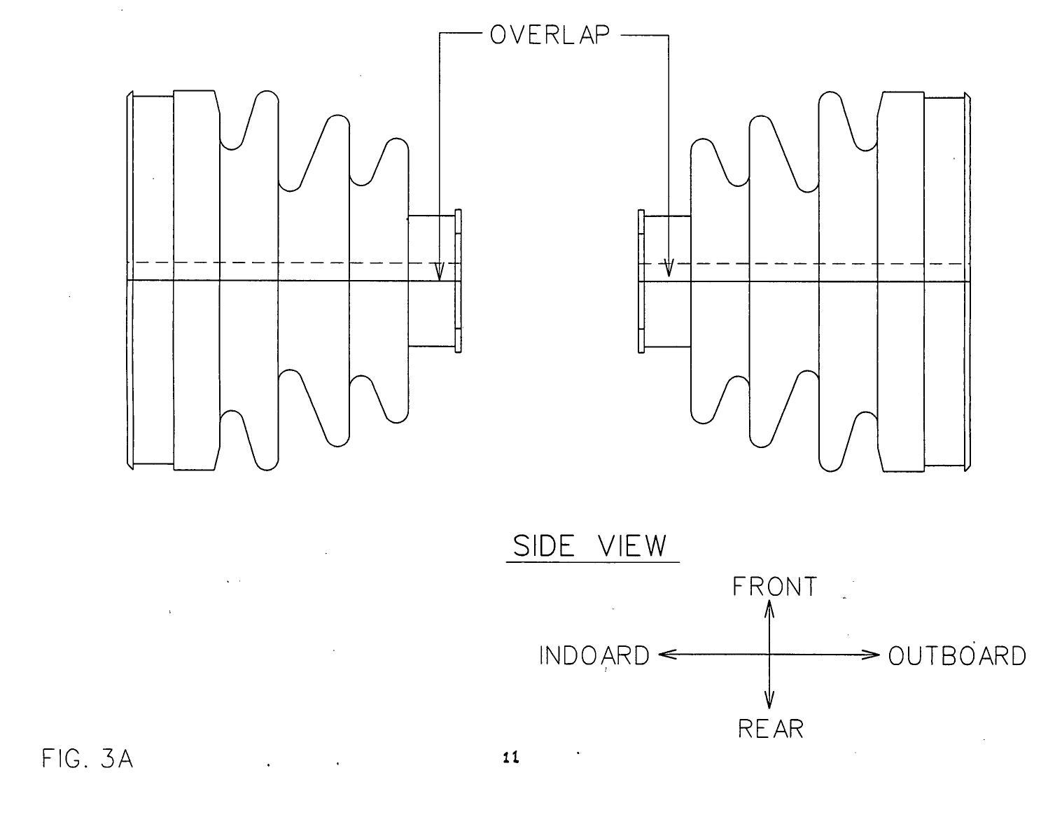

FIG. 4A illustrates the outside clamp, the inner clamp and adhesive.

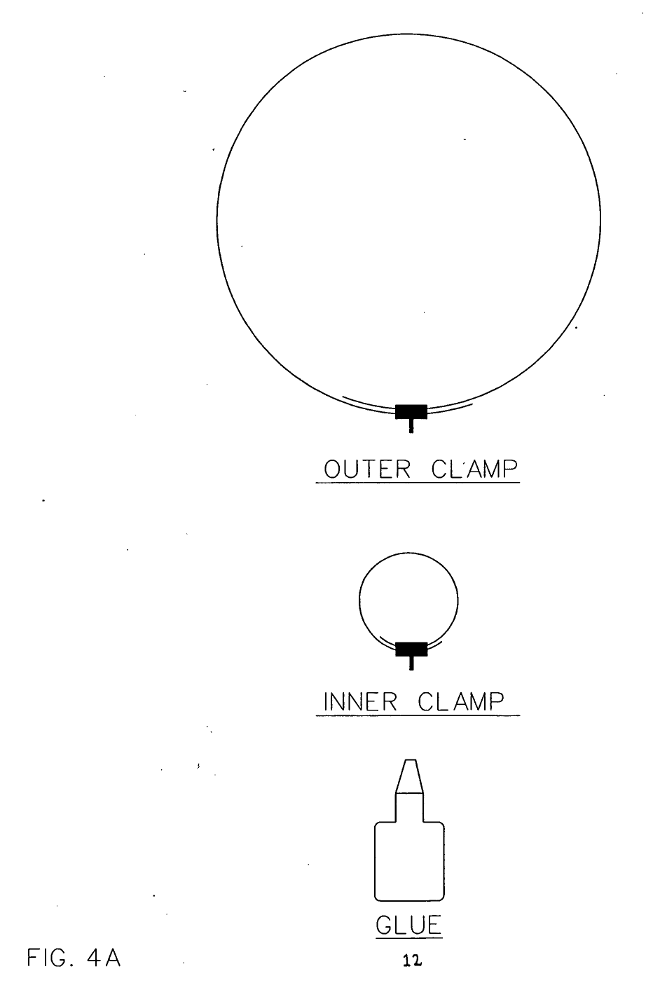

### DETAILED DESCRIPTION OF THE INVENTION

In this invention is a specific improvement in which a horizontal split will be across a boot that will have an indent either on the outside or inside of the boot. It will also have an overlap either on the inside or outside of the boot. The indent will cup the other end of the split while the overlap will lay on top or under depending which style is chosen see detail 1 or detail 2. As the vehicle moves forward the wind draft will pass over or under the overlap creating a smooth aerodynamic smoothness for the wind to pass. The direction of the overlap as its applied in detail 1 and 2 the wind passing through the boot will have little or no affect in parting the overlap from the boot itself. Also in regards to when the vehicle is traveling in the reverse direction the speed of the vehicle will be lesser in speed and again should have no bearing on splitting the boot apart. The accordion feature will aid in in keeping the boot in tack as well as the adhesive and clamps. The application of the Split-Boot Replacement should not be limited only to vehicles but many other things where the split of the boot can be applied to make removal and installation simpler. Also the shape of the Split-Boot Replacement can take other shapes and sizes.

1. What I claim as my invention is the indent on the inside of the boot.

2. What I claim as my invention is the overlap on the outside of the boot.

3. What I claim as my invention is the indent on the outside of the boot.

4. What I claim as my invention is the overlap on the inside of the boot.
